(19) United States
(12) Patent Application Publication
(10) Pub. No.: US 2003/0089733 A1
(43) Pub. Date: May 15, 2003

(54) Medication monitoring device

(76) Inventors: Russell P Cain, Columbia, MD (US); Bliss G Carkhuff, Laurel, MD (US); Joseph L Abita, Boyds, MD (US)

Correspondence Address: Ernest R Graf, The Johns Hopkins University, Applied Physics Laboratory, 11100 Johns Hopkins Road, Laurel, MD, 20723-6099, US

(21) Appl. No.: 10/169,825

(22) PCT Filed: Nov. 14, 2001
(86) PCT No.: PCT/US01/43656

(51) Int. Cl. B67D 5/06; B67D 5/38; B67D 5/24

(52) U.S. Cl. 222/30; 222/23

(57) ABSTRACT

A medication compliance monitor applicable to common approved dispensing containers is not apparent to a user patient. The monitor device applies to a container with a coil positioned thereabouts, uses a container top/cap including a metal material; and collects data with an electronic circuit operatively connected to the coil and housed in a housing coupled to the bottom of the container The device utilizes a medically approved common dispensing container; the typical medication label covers the coil and electronics.

### BACKGROUND OF THE INVENTION

The present invention relates to drug dispensing apparatus, and more particularly to a device for monitoring patient compliance with drug therapy. Patient compliance is a major factor affecting the efficacy of drug therapy. Prior attempts at developing combined drug dispensing and monitoring devices resulted in relatively bulky and expensive packages. Moreover, these devices did not employ Food and Drug Administration approved containers. One such device is discussed in M. A. Kass et al., “A Miniature Compliance Monitor for Eyedrop Medication,” Arch. Opthalmol., 102, 1500-1554 (1984). This device did not employ an approved Food and Drug Administration container, and it is not available commercially.

Physicians are typically interested in both the amount of a drug dispensed by a patient, as well as the time and date that the drug was dispensed by the patient. This is particularly useful in clinical trials of a drug. It is important that the patient not be aware of monitoring of drug dispensing. This is because patients may be inclined to change their routines if they were aware of the monitoring process. Consequently, it is useful to have a drug dispensing device that can monitor patient use of the medication without having the patient aware of the monitoring activity. The data collected by the device does not necessarily need to include the amount of medication dispensed by the patient. This is because the time and date that the patient administered the drug is often more important than the amount of medication dispensed by the patient. Accordingly, there is a need for a simple, low cost drug dispensing device that provides physicians with such time and date information. However, knowing the time and date information can indirectly infer the amount of medication in cases in which the applicator provides for dispensing a metered quantity of medicine, as is the case for prescription eye medication.

### SUMMARY OF INVENTION

It is an object of the present invention to provide a simple, low cost drug dispensing monitor device that tracks the time and date that a drug is dispensed.

It is a further object of the present invention to provide an objective measure of drug dispensing compliance.

It is another object of the present invention to provide a drug dispensing monitor device that is compatible with Food and Drug Administration approved drug-dispensing containers.

It is still a further object of the present invention to provide a device that monitors and records the date and time that a drug is applied and stores this information for subsequent readout and analysis.

It is still another object of the present invention to provide dispensing monitor device wherein the monitoring electronics and sensors are not visible to a user patient, and the shape of the dispensing container does not reveal their attached presence.

It is a further object of the present invention to provide a low-power dispensing monitor device capable of recording the time and date that a drug is dispensed.

It is still another object of the present invention to provide a reusable dispensing monitor device.

To achieve the above and other objects, the present invention provides, a dispensing monitor device that comprises: a container that includes a body having a bottom portion; a coil positioned about the body of the container; a top positionable on the container and including a metal and/or magnetic material; an electronics housing operatively coupled to the bottom portion of the container; and an electrical circuit housed by the electronics housing and operatively connected to the coil.

### BRIEF DESCRIPTION OF THE DRAWINGS

FIG. 1 is an exploded view of an embodiment of the invention.

FIG. 2 is an assembled view of the embodiment shown in FIG. 1.

FIG. 3 is a schematic cutaway view of an embodiment of the invention.

FIG. 4 is a schematic block diagram of an example of an electrical circuit in an embodiment of the invention.

FIG. 5 is a flow diagram of software for an exemplary embodiment of the invention.

FIG. 6 is an exemplary layout of the electrical components in an embodiment of the invention.

FIG. 7 is an example of adapter connections in an embodiment of the invention.

FIG. 8 is an example of adapter cabling in an embodiment of the invention.

### DESCRIPTION OF THE PREFERRED EMBODIMENTS

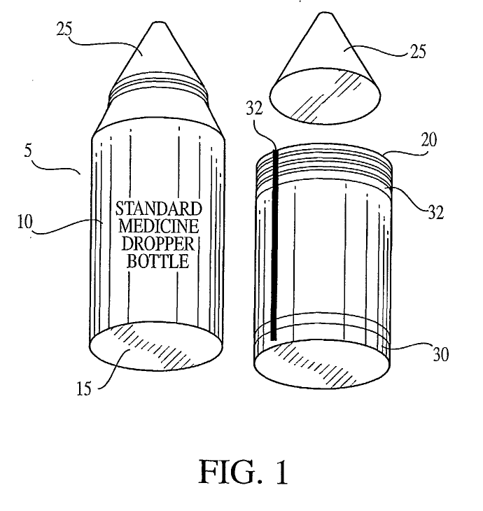

FIG. 1 is an exploded view of an embodiment of the invention. FIG. 1 shows a standard Food and Drug Administration (FDA) approved container 5. The container 5 has a body 10 and a bottom portion 15. In the preferred embodiment, a coil 20 is positioned around the body 10. The coil 20 comprises a variable reluctance sensor. In a preferred embodiment of the invention, the top or cap 25 of a standard container has only a slight, inconspicuous modification. In one approach caps would be modified as supplied by the provider; in another approach a standard unmodified cap would be removed and the physician would replace it with a sterile modified cap. In still another embodiment, a conformal cap can be inconspicuously attached to the standard cap of the provider thus affecting no modifications to the medicinal dispenser as provided. The cap modification does not interfere with or adversely affect the safety seal normally positioned around the container/cap interface nor does it impact the approved condition of the medication. In one embodiment, the cap 25 can include a magnetic or metal portion. The metal portion can be plated, embedded, or affixed to the cap 25. The presence of the metal near the coil 20 changes the electrical properties of the coil 20. Alternatively the cap 25 can include any other material that changes the inductance of the coil 20. Thus, the coil 20 has a first inductance when the cap 25 is on the container 10 and a second inductance when the cap 25 is not on (has been removed from) the container 10.

An electronics housing 30 is adjoined to the bottom portion 15 of the container 5 as shown in FIG. 1. A pair of thin leads 32 connects the coil 20 to an electrical circuit (described below) housed in the electronics housing 30. The leads 32 can comprise, for example, adhesive metallized Kapton.

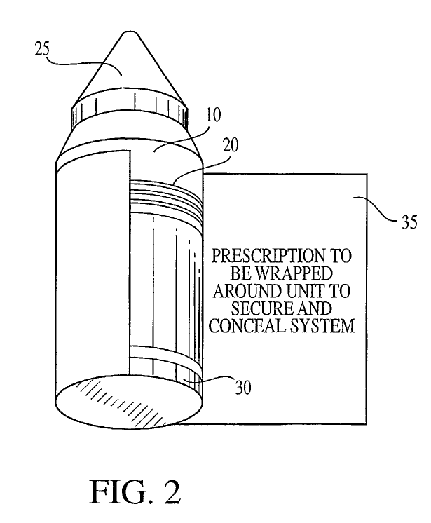

FIG. 2 is an assembled view of the embodiment shown in FIG. 1. The coil 20 slides over the body 10 of the container 5. Normally standard containers such as container 10 are translucent. So, as shown in FIG. 2, a label 35 conceals and renders the coil 20 unnoticeable to a user. The label 35 can also conceal the electronics housing 30. The label 35 can also function to hold the coil 20 and leads 32 in place and, if desired, can assist in holding the electronics housing 30 in place. Since the label 35 conceals the coil 20, leads 32 and electronics housing 30, the user of a dispenser in accordance with the present invention is unaware of the electronic nature of the container.

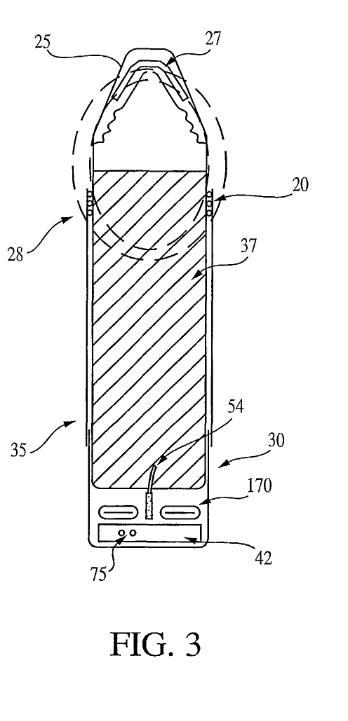

FIG. 3 is a schematic cutaway view of an embodiment of the invention. In FIG. 3, cap 25 includes a magnet 27 having an associated magnetic field (B-field) 28. The B-field 28 interacts with the coil 20. Removing the cap 25 causes coil 20 to sense movement of the B-field, and thus removal of the cap 25. FIG. 3 also schematically shows a fluid 37 to be dispensed. As with the embodiment shown in FIG. 2, the FIG. 3 embodiment includes a label 35 that protects and hides the coil 20 from the user. As discussed below, embodiments of the present invention can include a tilt sensor 54 shown in FIG. 3. A battery or batteries 170 shown in FIG. 3 provide power for the electronics housed in, for example, a module 42. An interface 75 provides an electrical connection to the electronics. The interface could also be, for example, a radio frequency (rf) interface or an infrared interface. The particular interface chosen depends upon the application for the present invention.

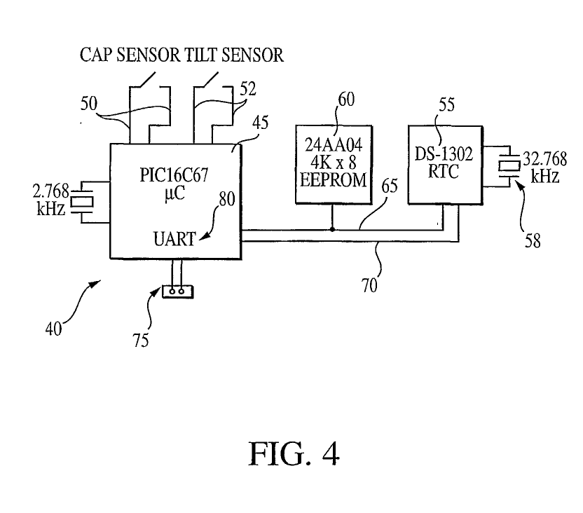

FIG. 4 is a schematic block diagram of an example of an electrical circuit 40 in an embodiment of the invention. Referring to FIG. 4, the system includes a microcontroller 45. In a preferred embodiment of the present invention, the microcontroller 45 can comprise any microcontroller or microprocessor. To reduce power, it is desirable to use a device with low power requirements. One example of the many available microcontrollers is an 8-bit microcontroller, PIC16C67, manufactured by Microchip Technology, Inc. The microcontroller 45 used in the preferred embodiment includes 2 Kbytes of electrically programmable read only memory. It is also small, approximately 7.9 mm×10.33 mm. For the embodiment of the invention the low power consumption aids in providing a long lifetime for the dispenser. The microcontroller consumes a maximum of 48 μA at 3.0 volts. The microcontroller has a power down or sleep mode in which the power consumption falls to only 5 μA at 3.0 volts. Contacts 50 connect to the leads 32 to electrically couple the coil 20 to the microcontroller 45. It will be appreciated to those skilled in the art that there are a wide variety of other devices that can be used to practice the present invention. This discussion of a specific microcontroller is merely for illustration. Those skilled in the art will recognize that the present invention is not limited to any particular microcontroller or microprocessor. The selection of a microcontroller or microprocessor to practice the present invention depends upon the design of the particular application.

The electrical circuit 40 also includes a real time clock 55. In a preferred embodiment of the present invention, the real time clock 55 can comprise any real time clock. It need not be a separate device; it can be included on the microcontroller 45. An example of one of the many available real time clocks is part number DS-1302 manufactured by Dallas Semiconductor, Inc. In the exemplary embodiment shown in FIG. 4, a 32.768 kHz crystal 58 drives the real time clock 55. The real time clock 55 can function as both a clock and calendar. The calendar has leap year compensation. The date and time are stored as binary-coded decimal (BCD) values in seven internal registers that record month, day, hour, and minute. The time and date data in the internal registers can be stored in an electrically erasable programmable read only memory (EEPROM) 60. Any EEPROM can be used with the present invention. One example or the may available EEPROMs is part number 24AA04 manufactured by Microchip Technology, Inc. As will be understood by those skilled in the art, the present invention is not limited to any particular EEPROM device. The selection of an EEPROM device depends upon the requirements of a particular application. Both the real time clock 55 and the memory 60 communicate with the microcontroller 45 through a two-wire serial Inter-Integrated Circuit (I²C) bus 65. The real time clock has a control line 70 that enables the real time clock external interface. When the line 70 is low, the real time clock keeps time, but draws only about 1 μwatt of power.

The memory 60 stores the date and time values obtained from the real time clock 55. In an exemplary embodiment of the present invention, the memory 60 includes 4 Kbytes of memory, and communicates with the computer over the bus 65. Storing the date and time data in an EEPROM ensures that if there is a loss of power, data will be retained. Also, the communication of the memory 60 and microcontroller 45 make it difficult for a user to tamper with the data. Moreover, the cells of the EEPROM are typically capable of one million read/write operations. This far exceeds the expected lifetime of a dispenser in accordance with the invention.

The electrical circuit 40 can provide the collected data via an interface 75 discussed below. The microcontroller 45 includes a communication interface 80, such as a UART to provide the desired data to the interface 75. The interface can be a standard RS-232 interface. The RS-232 drive electronics can be housed in an adapter as discussed below. This reduces the size of the dispenser. Alternatively, the interface can comprise a wireless interface, such as an inductive loop or a rf link that could be powered by induced rf power.

A dispenser in accordance with the present invention can also include a tilt sensor. By way of example, common tilt sensors include mercury switches, sonic sensors, and capacitive sensors. Since the dispensing container is sealed and isolated from the monitor electronics, there is no risk of contamination of the medicinal fluid or other potential risk to the patient, e.g., from mercury. If included in a dispenser, this switch would be connected to connectors 52 shown in FIG. 4. As an example, the mercury switch closes a connection (connected to connectors 52) when the dispenser bottle is inverted within ±15° from fully inverted (vertical) position. Transitions to and from vertical move the microcontroller 45 from its power down or sleep mode to its active mode which remains independent of bottle position for some time, for example 3 minutes, after activation. This insures that when the dispenser is inverted, the system does not repetitively activate and de-activate. Instead, the system remains active until the bottle is turned upright, goes to sleep, and then waits for the next inversion. There is provision for the circuits to de-activate when the dispenser remains inverted over a certain short period of time; thus preventing power drain if the dispenser remains off the vertical position when stored.

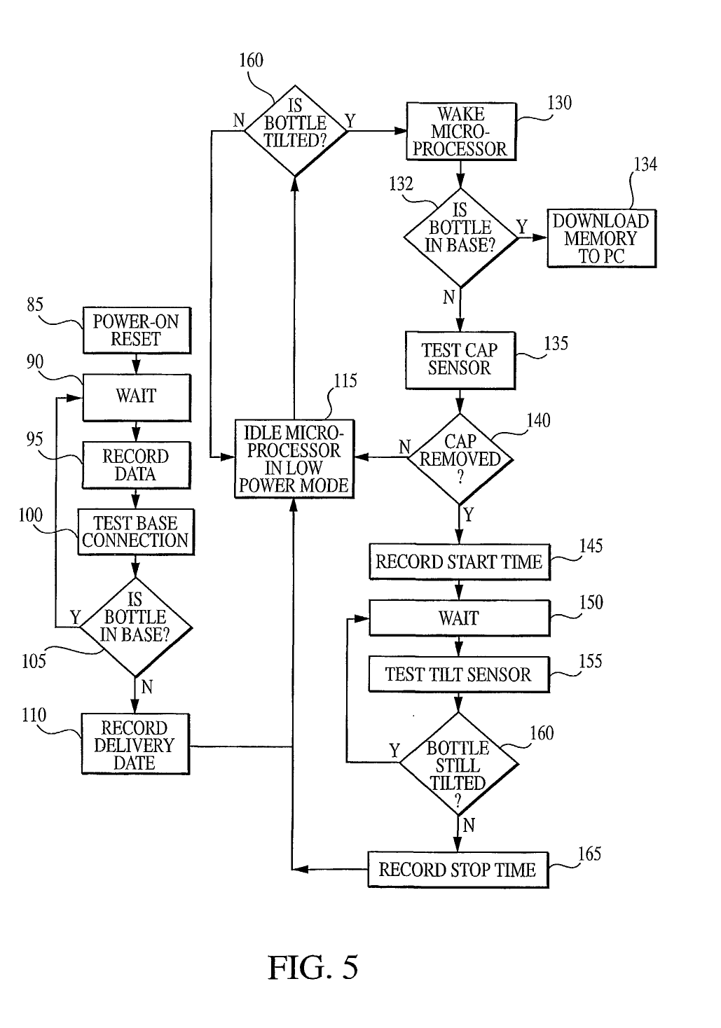

FIG. 5 is a flow diagram of software for an exemplary embodiment of the invention. The software can be stored in a memory within the microcontroller 45, or can be stored external to the microcontroller 45, depending upon the particular component used as the microcontroller 45. Referring to FIG. 5, the software begins at step 85 when power is applied to the system, such as by installing a battery (discussed below) in the system. In the example of a medical dispenser this power up could occur in a physician's or pharmacist's office. At step 90 the system waits to allow the bottle to be stabilized, such as being set in a communications adapter. The date and time can be recorded at step 95, followed by the system testing the adapter base connection at step 100. As will be appreciated by those skilled in the art, such a test could comprise activating a request-to-send signal and waiting for a clear-to-send signal. In step 105, if the clear-to-send signal is received, the dispenser is still in the adapter base and processing returns to step 90. If, however, the clear-to-send signal is not received, then processing continues to step 110. Here it is assumed that the dispenser has been removed from the adapter base and delivered to the user. Consequently, step 110 records the delivery time and date. The microcontroller 45 then goes into its power down or sleep mode in step 115.

FIG. 5 also illustrates the program logic for a dispenser that includes an optional tilt sensor, and downloading recorded data. With the optional tilt sensor, tilting the dispenser causes the tilt sensor to sense the tilt of the dispenser. This event is sensed at step 160 and wakes the microcontroller 45 (step 130). The microcontroller 45 monitors, for example, the communications interface 80 to determine if it has been inserted into the adapter base at step 132. This monitoring can be in a manner similar to that described with respect to step 105. If the microcontroller 45 has been inserted the data is downloaded via RS-232 to a computer at step 134. Next, the microcontroller 45 tests for the presence of the top 25 in step 135. As an example, the microcontroller 45 can test the frequency of an LC oscillator that includes coil 20. Depending upon the location of the top 25, the oscillator will have a different inductance, thus a different frequency. The microcontroller 45 can count the time elapsed for a period of the oscillator to detect the frequency of the oscillator.

In step 140, the microcontroller 45 tests for the presence of the top 25. If the top 25 is not removed, the computer returns to step 115 and to its sleep mode of operation. If the dispenser top 25 has been removed, microcontroller 45 records the time at step 145. The time can be just the month, day and current time if the year was stored at step 95. Otherwise, the time would include the year. The time can be stored in EEPROM memory 60 shown in FIG. 4. If the dispenser were used as a medication dispenser, this time would constitute the time that the user begins to dispense the medication. The microcontroller 45 then waits at step 150 before testing the tilt sensor in step 155. If the dispenser is still tilted as sampled in step 160, the microcontroller 45 continues the waiting and testing steps 150 and 155. If, however, the dispenser is no longer tilted, the microcontroller 45 records the time at step 165. Again, if the dispenser were used as a medication dispenser, this time would constitute the time that the user finishes dispensing the medication. Again, this time can be stored in EEPROM memory 60 shown in FIG. 4. The microcontroller 45 then returns to step 115 and to its sleep mode of operation.

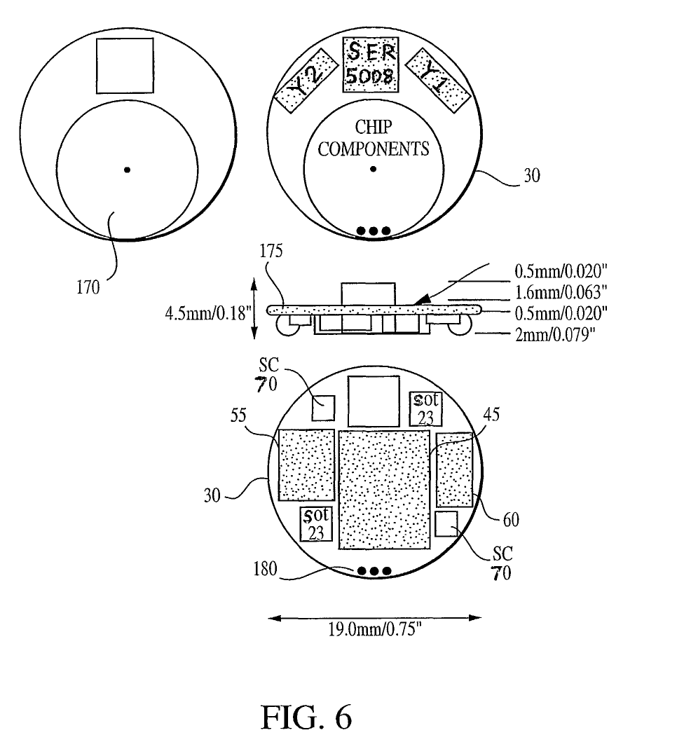

FIG. 6 is an exemplary layout of the electrical components in an embodiment of the invention. In FIG. 6, Y1 and Y2 correspond to the crystals shown in FIG. 4; SER 5008 identifies a tilt sensor; SC70 and SOT 23 represent common signal conditioning circuits; and the three dots at the bottom of the housing 30 represent contacts for GND, SDA (serial data) and SCK (serial clock). In the illustrated embodiment, a battery 170 powers the electrical circuit 40. To facilitate a small size for the electrical circuit 40, the battery 170 is preferably a watch type battery, such as a 3-volt lithium cell. The battery 170 is mounted on a circuit board 175. The circuit board 175 can have an induction coil wound on the surface thereof as part of the interface 75.

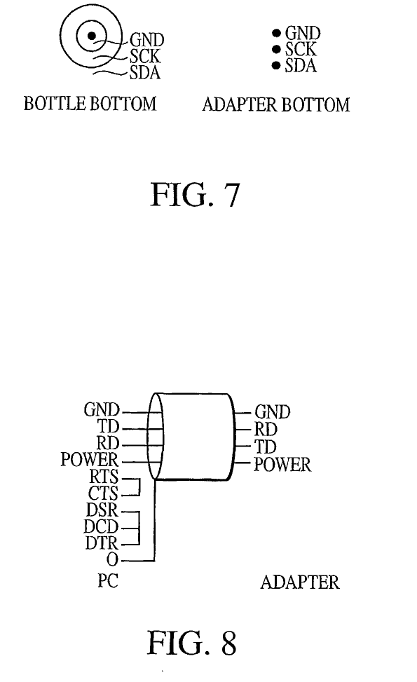

FIG. 7 is an example of adapter connections in an embodiment of the invention. The bottom of the electronics housing 30 can include a conductive pattern 180 shown in FIG. 6. As denoted in FIG. 7, the conductive pattern can be used for ground (GND). The circular patterns shown in FIG. 7 are the circular contacts for SCK and SDA in the adapter to mate with the contacts for SCK and SDA on the bottle which in turn connect to the three beads in FIG. 6. With circular contacts, the system makes contact no matter which orientation the bottle is inserted into the adapter. The conductive pattern 180 electrically mates with corresponding conductors

FIG. 8 is an example of adapter cabling in an embodiment of the invention. The adapter cabling shown in FIG. 8 can be used to connect the adapter to, for example, a personal computer or personal data assistant. Communications between the electrical circuit 40 and the personal computer take place via the interface 75. As noted above, the interface 75 can comprise any suitable communications link, such as a direct connection (FIG. 7) or via an inductive coil. Use of an inductive coil allows the microcontroller 45 to communicate with, for example, a personal computer without the need for electrical contacts on the electronics housing 30.

As an additional element, a dispenser in accordance with the present invention can also include a pressure sensor. The pressure sensor is a thin flexible film that can be formed to function as the label 35 or be placed (hidden) between the label inside and the dispenser outside surfaces. It will detect minute pressure changes from the patient squeezing on the dispenser and will only operate when the dispenser has been inverted and the top 25 has been removed. As those skilled in the art will recognize, the microcontroller 45 can monitor the amount of pressure and relate it to the amount of medication delivered. The pressure sensor can be either a piezoelectric, capacitive, or a polymer/carbon resistance sensor. Either sensor is only approximate 1-2-5 mils thick and therefore would be inconspicuous. When the top 25 has been removed and the clock 55 awakened, the microcontroller 45 can monitor the state of the pressure sensor. The microcontroller 45 could also use the pressure sensor to determine the duration of the administration of medication.

1. A dispensing monitor device comprising:
a container including a body having a bottom portion;
a coil positioned about the body of the container;
a top positionable on the container and including a metal material;
an electronics housing operatively coupled to the bottom portion of the container; and
an electrical circuit housed by the electronics housing and operatively connected to the coil.

2. A dispensing and monitoring device according to claim 1, wherein the electrical circuit comprises:
a computer operatively coupled to the coil;
a clock; and
a memory.

3. A dispensing and monitoring device according to claim 2, wherein the computer includes the clock and a memory for storing a program.

4. A dispensing and monitoring device according to claim 2, wherein the coil has a first inductance when the cap is positioned on the container and a second inductance when the cap is not positioned on the container.

5. A dispensing monitor device according to claim 2, further comprising means for communicating data operatively connected to the computer.

6. A dispensing and monitoring device according to claim 5, wherein the means for communicating comprises an electric connection for connecting to an adapter.

7. A dispensing and monitoring device according to claim 5, wherein the means for communicating comprises an induction coil.
